(19) United States
(12) Patent Application Publication
(10) Pub. No.: US 2026/0019324 A1
(43) Pub. Date: Jan. 15, 2026

(54) 5G COMPUTE, STORAGE, AND NETWORK MANAGEMENT OFFLOAD TO DPU

(71) Applicant: MICROSOFT TECHNOLOGY LICENSING, LLC, Redmond, WA (US)

(72) Inventors: Sharad AGARWAL, Seattle, WA (US); Ganesh SRINIVASAN, Hyderabad (IN); Osama Bin ZIA, Vancouver (CA)

(21) Appl. No.: 18/984,932

(22) Filed: Dec. 17, 2024

(30) Foreign Application Priority Data
Jul. 12, 2024 (IN) 202411053530

(51) Int. Cl. H04L 41/0663; H04L 9/40; H04L 67/101

(52) U.S. Cl. CPC H04L 41/0663; H04L 63/04; H04L 67/101

(57) ABSTRACT

A digital processing unit (DPU) is configured to disaggregate computing service provider functions of a cloud service provider from hosts of an edge computing network. The hosts are implemented on servers hosting a plurality of virtual machines or containers. The edge computing network comprises computing and storage devices configured to extend computing resources of the cloud service provider to remote users of the cloud service provider at a location remote from the cloud service provider. The DPU executes a computing service provider function that is disaggregated from processing cores of the server.

### PRIORITY APPLICATION

The present application claims priority to foreign application filed in the India Patent Office, Indian Patent application Serial No. 202411053530, filed Jul. 12, 2024, the content of which is hereby incorporated by reference in its entirety.

### BACKGROUND

A data center houses computer systems and various networking, storage, and other related components. Data centers, for example, are used by service providers to provide computing services to businesses and individuals as a remote computing service or provide “software as a service” (e.g., cloud computing). Service providers may also utilize edge sites that may include a geographically distributed group of servers and other devices that work together to provide efficient delivery of content to end-users of data center services, with the goal being to provide services with high availability and improved latencies. The efficient processing of data traffic and efficiently utilizing the physical and virtual network devices are important for maintaining scalability and efficient operation in such networks.

It is with respect to these considerations and others that the disclosure made herein is presented.

### SUMMARY

Users of a computing service such as a cloud computing service may be provided use of such services via computing and storage resources of the computing service at a remote location (“edge site”). Edge sites enable a service provider to extend cloud services to local deployments using a distributed architecture that enables federated options for local and remote data and control management. It is desirable to provide high levels of computing availability at an edge site while at the same time providing performance and minimizing cost.

The present disclosure describes various techniques and systems to more efficiently utilize computing and networking resources and use less physical space and power at an edge site by disaggregating and offloading cloud network management functions from servers, the quantity of which are often physically limited in edge sites. By offloading network management tasks to hardware-based network devices such as a smart network interface card (sNIC) or data processing unit (DPU), the capacity of CPU cores in the servers can be reserved for the user's applications and reducing the need for more servers at the edge site. While virtual machines running on the servers can be used to perform the cloud network management as well as other functions, the cost of servers and switches are high in contrast to offloading the functions to dedicated hardware such as DPUs.

The disclosed embodiments provide a way to disaggregate cloud network management services to hardware-based network devices such as a DPU in order to increase efficiency and reduce consumption of core processing and other resources. Disaggregation or offloading of network services refers to allocation of the cloud network management functions so that they need not be performed and co-located within any particular virtual machine or container running on a general-purpose server.

The disclosed embodiments provide a way for the hardware-based network devices to perform the cloud network management functions, for example in the DPU, and disaggregate these functions from running on server hosts. The hardware-based network device can perform these functions without the need to invoke software-based processing in VMs. For example, the DPU can be used to house and offer networking and application services without traffic having to enter the server host, greatly conserving CPU capacity.

The described techniques can allow for remote edge computing environments to support a variety of configurations while maintaining efficient use of computing resources such as processor cycles, memory, network bandwidth, and power. This Summary is provided to introduce a selection of concepts in a simplified form that are further described below in the Detailed Description. This Summary is not intended to identify key features or essential features of the claimed subject matter, nor is it intended that this Summary be used to limit the scope of the claimed subject matter. Furthermore, the claimed subject matter is not limited to implementations that solve any or all disadvantages noted in any part of this disclosure.

### DRAWINGS

The Detailed Description is described with reference to the accompanying figures. In the description detailed herein, references are made to the accompanying drawings that form a part hereof, and that show, by way of illustration, specific embodiments or examples. The drawings herein are not drawn to scale. Like numerals represent like elements throughout the several figures.

FIG. 1 is a diagram illustrating an example architecture in accordance with the present disclosure;

FIG. 2 is a diagram illustrating a data center in accordance with the present disclosure;

FIG. 3 is a diagram illustrating an architecture for implementing virtual services in accordance with the present disclosure;

FIG. 4 is a diagram illustrating an example architecture in accordance with the present disclosure;

FIG. 5 is a diagram illustrating an example architecture in accordance with the present disclosure;

FIG. 6 is a flowchart depicting an example procedure in accordance with the present disclosure;

FIG. 7 is an example computing system in accordance with the present disclosure.

### DETAILED DESCRIPTION

In some computing environments that provide virtualized computing and storage services, various computing and network services may be configured to enable the service provider to deploy their footprints closer to the user's premises, thereby extending the reach of the computing and network services closer to the user premises. For example, an enterprise that provides network carrier services may want computing services located closer to their networks or their customers using edge sites, or a manufacturer may want to deploy computing resources closer to their facilities. Users of virtualized computing resources may benefit in many ways by deploying resources such as virtual machines on resources that are located closer to their premises. Additionally, localization of computing and storage devices may enable some users to more effectively meet data residency, compliance, latency, and other requirements, while continuing to benefit from many of the advantages of utilizing remote and/or virtualized computing services, such as scalability and flexibility. As used herein, “resources” may refer to various types of multi-dimensional resources including CPU, GPU, memory, etc.

Efficient management of the end-to-end capability services by the service provider can enable an experience that is seamless and consistent when using edge sites. The integration of local and remote resources with a comprehensive remote resource management approach can minimize the overhead for the service provider by maximizing the capabilities of the edge site. The effective distribution of cloud network management functions can be determined based on the implications for various performance and security implications such as latency and data security.

In an example, many cell towers are situated with a baseband unit (BBU). The BBU typically has a small amount of space which can accommodate a small number of servers and thus provides a limited amount of compute capacity. Additionally, power costs can be variable as power pricing may be subject to local utilities rather than the bulk pricing that may be available at data centers. It would be inefficient to use up the capacity of the cloud network management functions for network management and orchestration tasks at the expense of running the customer's applications, such as Artificial Intelligence and/or Machine Learning (AIML) agents, radio access network (RAN) applications, and other applications.

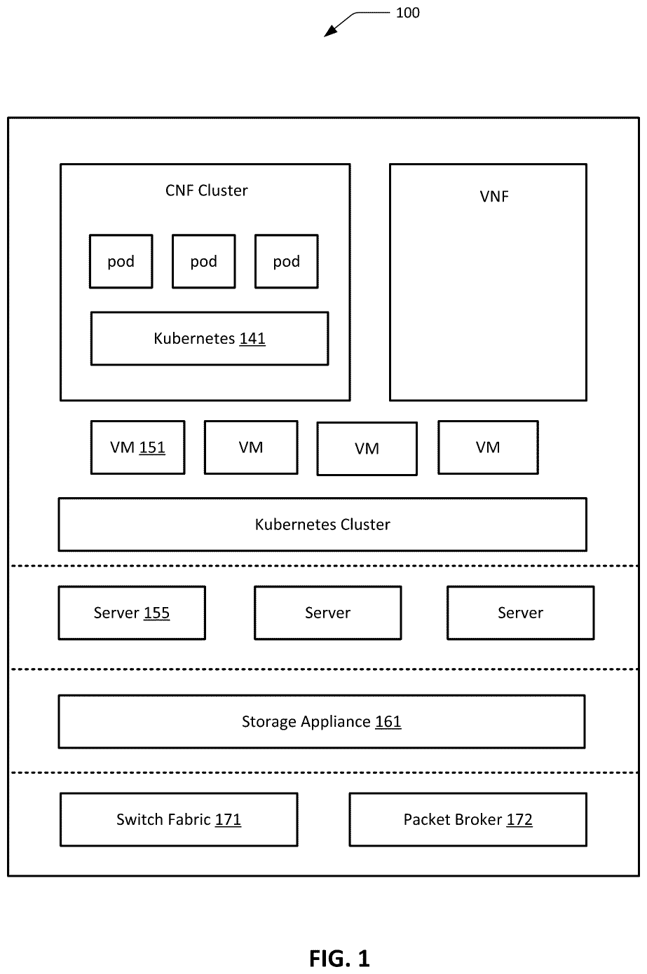

Referring to FIG. 1, illustrated is a high-level architecture of cloud network management functions at an edge site including a switch fabric 171 and packet broker 172, storage appliance 161, and virtual machines (VMs) 151 with Kubernetes 141 running on top of the VMs 151 that run on servers 155. Examples of other network management functions include network protocols, compute fabric, and storage fabric.

In some embodiments, the DPU can serve as the root of trust to enable zero touch provisioning at the edge site. Thus the DPU can be the root of trust to enable secure installation of operating systems (OSes) and/or applications from the service provider at the edge site with assurance that the hardware is owned by the network operator. In an embodiment, the service provider installs an image at the DPU that includes cryptographic proof that the DPU is running trusted code. Thus the entire server can be bootstrapped based on this root of trust. In another example, the disclosed embodiments can be applied to on-premise edge for AI inference. Some users will run cloud-based edges on their premises to perform fast AI inference. It is desirable to offload as much of the cloud stack or fabric as possible to the DPU, thereby maximizing the host CPU/GPU for the user's AI workloads.

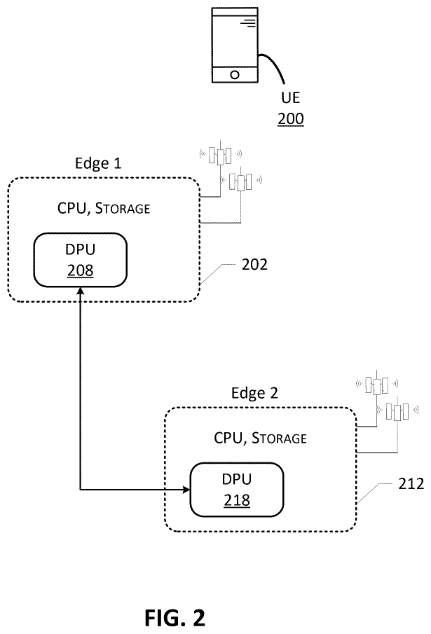

In some embodiments, offloading to the DPU can enable failover between servers and edge sites. Some functions running at an edge site may be susceptible to failure such as functions perform RF processing. In such cases, the users connected to the cell tower being served by the failed function can be disconnected for the time that it takes to switch to a backup server or for the server to reboot. As disclosed herein, because the DPU is in the communications path between the cell tower and the service provider, the service provider can efficiently provide an alternative processing path with little or no delay. For example, as shown in FIG. 2, edge site 202 with DPU 208 provides services to UE 200. In the event of a service disruption at edge 202, DPU 208 can communicate with DPU 218 at edge site 212 to minimize or avoid disruption to services provided to UE 200.

In an embodiment, for enterprises managing and operating multiple servers providing time-sensitive services, 5G provides a way to implement a robust network that is less prone to interference as compared to protocols such as WiFi, or less costly and cumbersome compared to wired networks. An enterprise can implement 5G on an unlicensed band that is less prone to interference. The offloading of the network management functions to the DPUs allows the enterprise to seamlessly scale 5G services from the cloud to the enterprise premises and without the high cost of building out a localized switch fabric.

In some embodiments, DPU-based NICs can have multiple compute capabilities (e.g., ARM cores and custom silicon in ASICs). Thus at least three paths can be implemented on a DPU: slow path (host CPU), medium path (ARM CPU on DPU), and fast path (custom silicon or ASIC on DPU). Additional paths can be implemented in some embodiments, When a plurality of functions are to be implemented (e.g., container management, storage management, Border Gateway Protocol (BGP), virtual private network (VPN), Internet Protocol Security (IPSec), etc.), it may not be possible to assign all of the functions to the fast path. Thus it is necessary to determine which functions to assign to each of the paths. This determination can be a runtime decision that is based on incoming workloads, where functions are moved dynamically between the processing paths to allow the most critical functions to be assigned to the fast path and other functions assigned to the medium and slow paths (or other paths depending on the implementation). Alternatively, the assignment of functions to the paths can be a configuration that is based on user workloads at deployment time, where a compiler or configuration generator can determine the assignments to the paths, for example.

The present disclosure enables the offloading of functionality that is typically implemented in servers and switches into the DPU. This enables users to more efficiently implement edge sites with a server and DPU that is more cost effective and scalable.

The disclosed embodiments may be implemented in a hardware-based acceleration device that implements various ways of leveraging hardware acceleration and offloading techniques to perform a function, such as implementing tasks in hard ASIC logic, implementing tasks in soft (configurable) FPGA logic, implementing some tasks as software on FPGA software processor overlays, implementing some tasks as software on hard ASIC processors, or a combination thereof. In some embodiments, the hardware-based acceleration device is a network communications device, such as a network interface card (NIC) or a DPU. The DPU can be configured to perform complex processing. The DPU, in one example, is a processing component that is configured for packet processing and can be implemented as hardware, software, or a combination. In one embodiment, the DPU is implemented as an ASIC. The various described acceleration devices can generally be referred to as hardware-based network interface devices. In some embodiments, the disclosed embodiments can be implemented in general purpose and/or specialized CPUs, GPUs, or network processing units (NPUs).

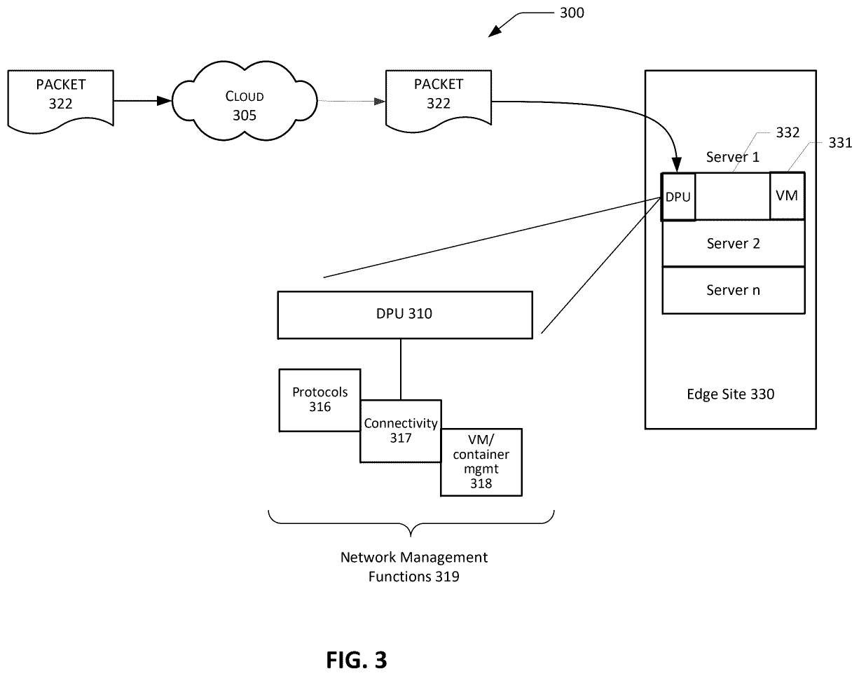

Referring to FIG. 3, illustrated is an example of network function disaggregation, according to an embodiment. A computing environment 300 includes an edge computing network (edge site 330) that includes a plurality of computing nodes such as servers 332. The servers 332 host a plurality of virtual machines 331 and digital processing units (DPUs) 310. The various illustrated components such as servers 332 and DPUs 310 are configured to implement, for example, a software defined network (SDN). The DPU 310 receives an input data packet 322, for example via cloud 305. The input data packet 322 can be addressed to an endpoint hosted by a VM 331. The DPU 310 applies a network management function 319 to the input data packet 322. The network management function 319 can include protocols 316, connectivity 317, VM/container management 318, as well as other networking functions 319. Other networking functions 319 can include a network fabric. The networking functions 319 can each be implemented on DPU 310, which is disaggregated from physical dependencies on particular computing nodes (e.g., servers 332) that are hosting the virtual machines 331. The networking functions 319 can also be disassociated from logical connections to the plurality of servers 332. The DPU 310 forwards the input data packet 322 to one of the servers 332. The server 332 is configured to apply applications associated with a user of the edge site 330. The networking functions 319 can also be referred to as cloud service provider function or computer service provider function.

Because the described functions are disaggregated and offloaded, DPUs can be added or deleted and swapped out as necessary. Each of the described functions can be designed and deployed optimally for the function and scale required. Additionally, disaggregation and offloading enables individual functions to be optimized at their own rate of development.

Disaggregation and offloading provides architectural flexibility to take advantage of dedicated processing provided by the DPUs to extend the advantages to other computing and cloud functions. Connecting functions together with logical tunnels enables disaggregation of functions seamlessly across the processing domains. High speed high-capacity network switching enables lower cost of disaggregation with negligible latencies.

By offloading servers to DPUs, the capacity requirements of an edge site can be planned more efficiently. Furthermore, by exposing such services to the users, the users can opt for cloud network services over similar functions currently only offered on server platforms or switches. These cloud network services can be expanded in capacity or reduced in cost relative to current implementations that are coupled with a server or switch. Additionally, DPUs can expose the lowest latency implementations when required for cloud solutions. For example, 5G services are examples of services that are sensitive to latency and jitter.

DPUs can be deployed as single units or within servers or appliances or other such devices that house a plurality of DPUs. However, servers are also more cost effective as power and cooling for DPUs is more efficient in a shared space rather than housing a DPU separately.

The disclosed embodiments allow for removal of SDN functions from host servers while only implementing new software to provide location services indicating where the floating NICs are located and their availability/capacity for SDN functions.

Referring to the appended drawings, in which like numerals represent like elements throughout the several FIGURES, aspects of various technologies for network disaggregation techniques and supporting technologies will be described. In the following detailed description, references are made to the accompanying drawings that form a part hereof, and which are shown by way of illustration specific configurations or examples.

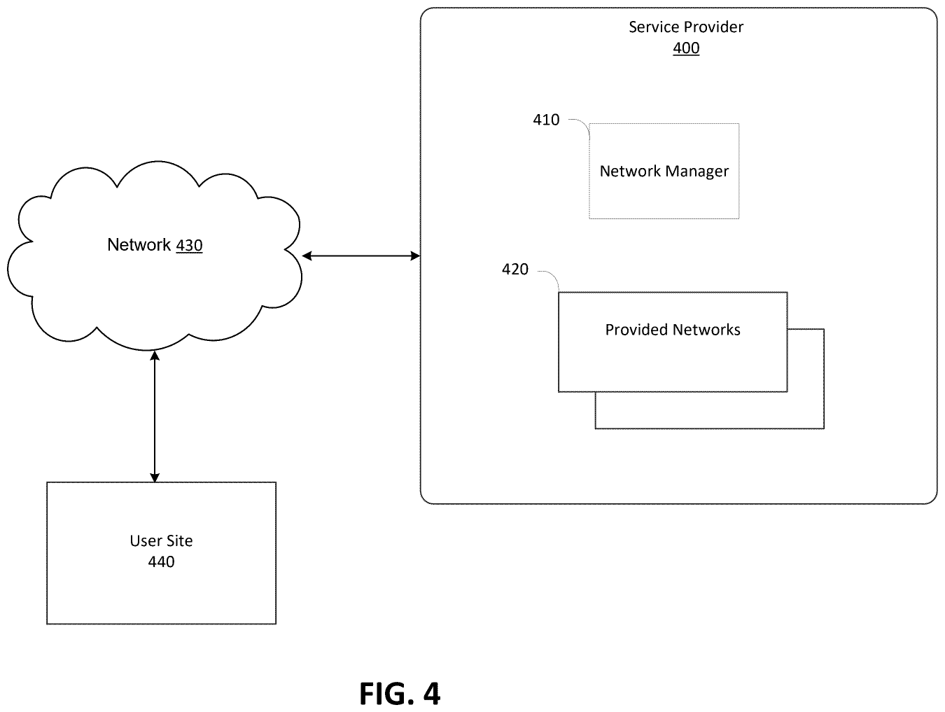

FIG. 4 illustrates an example computing environment in which the embodiments described herein may be implemented. FIG. 4 illustrates a service provider 400 that is configured to provide computing resources to users at user site 440. The user site 440 may have user computers that may access services provided by service provider 400 via a network 430. The computing resources provided by the service provider 400 may include various types of resources, such as computing resources, data storage resources, data communication resources, and the like. For example, computing resources may be available as virtual machines. The virtual machines may be configured to execute applications, including Web servers, application servers, media servers, database servers, and the like. Data storage resources may include file storage devices, block storage devices, and the like. Networking resources may include virtual networking, software load balancer, and the like.

Service provider 400 may have various computing resources including servers, routers, and other devices that may provide remotely accessible computing and network resources using, for example, virtual machines. Other resources that may be provided include data storage resources. Service provider 400 may also execute functions that manage and control allocation of network resources, such as a network manager 410. Service provider 400 may also provide networks accessible at the service provider 400 such as provided networks 420.

Network 430 may, for example, be a publicly accessible network of linked networks and may be operated by various entities, such as the Internet. In other embodiments, network 430 may be a private network, such as a dedicated network that is wholly or partially inaccessible to the public. Network 430 may provide access to computers and other devices at the user site 440.

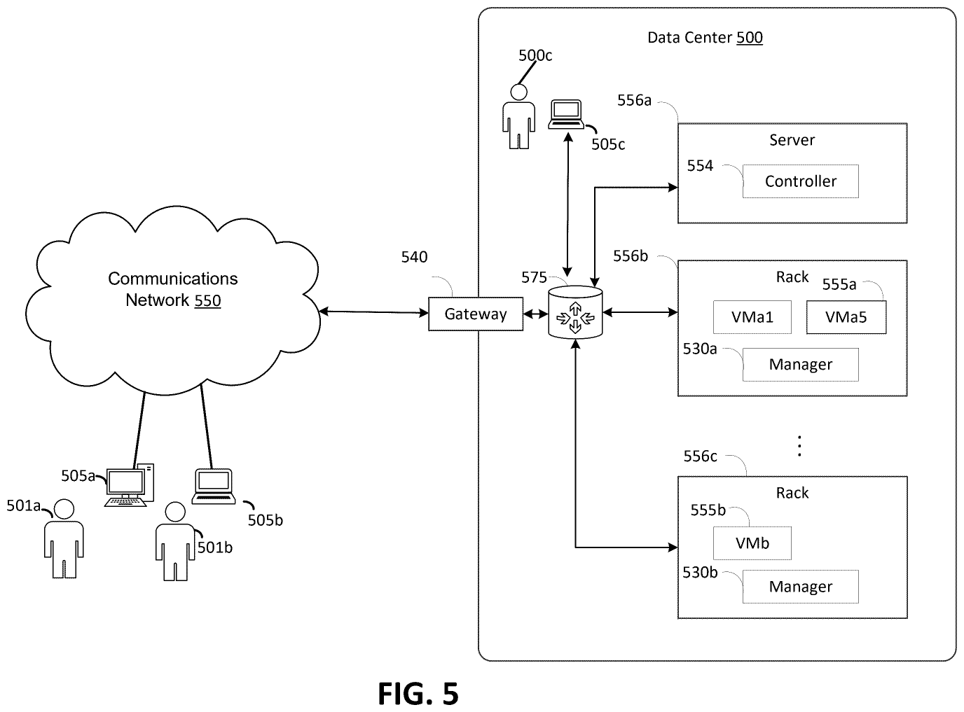

FIG. 5 illustrates an example computing environment in which the embodiments described herein may be implemented. FIG. 5 illustrates a data center 500 that is configured to provide computing resources to users 500a, 500b, or 500c (which may be referred herein singularly as “a user 501” or in the plural as “the users 501”) via user computers 505a,505b, and 505c (which may be referred herein singularly as “a computer 505” or in the plural as “the computers 505”) via a communications network 550. The computing resources provided by the data center 500 may include various types of resources, such as computing resources, data storage resources, data communication resources, and the like. Each type of computing resource may be general-purpose or may be available in a number of specific configurations. It should be appreciated that although the embodiments disclosed above are discussed in the context of virtual machines, other types of implementations can be utilized with the concepts and technologies disclosed herein, for example containers. For example, computing resources may be available as virtual machines or containers. The virtual machines or containers may be configured to execute applications, including Web servers, application servers, media servers, database servers, and the like. Data storage resources may include file storage devices, block storage devices, and the like. Each type or configuration of computing resource may be available in different configurations, such as the number of processors, and size of memory and/or storage capacity. The resources may in some embodiments be offered to clients in units referred to as instances or containers, such as container instances, virtual machine instances, or storage instances. A virtual computing instance may be referred to as a virtual machine and may, for example, comprise one or more servers with a specified computational capacity (which may be specified by indicating the type and number of CPUs, the main memory size and so on) and a specified software stack (e.g., a particular version of an operating system, which may in turn run on top of a hypervisor).

Data center 500 may correspond to network 100 in FIG. 1. Data center 500 may include servers 556a, 556b, and 556c (which may be referred to herein singularly as “a server 556” or in the plural as “the servers 556”) that may be standalone or installed in server racks, and provide computing resources available as virtual machines 555a and 555b (which may be referred to herein singularly as “a virtual machine 555” or in the plural as “the virtual machines 555”). The virtual machines 555 may be configured to execute applications such as Web servers, application servers, media servers, database servers, and the like. Other resources that may be provided include data storage resources (not shown on FIG. 5) and may include file storage devices, block storage devices, and the like. Servers 556 may also execute functions that manage and control allocation of resources in the data center, such as a controller 554. Controller 554 may be a fabric controller or another type of program configured to manage the allocation of virtual machines on servers 556.

Referring to FIG. 5, communications network 550 may, for example, be a publicly accessible network of linked networks and may be operated by various entities, such as the Internet. In other embodiments, communications network 550 may be a private network, such as a corporate network that is wholly or partially inaccessible to the public.

Communications network 550 may provide access to computers 505. Computers 505 may be computers utilized by users 501. Computer 505a, 505b or 505c may be a server, a desktop or laptop personal computer, a tablet computer, a smartphone, a set-top box, or any other computing device capable of accessing data center 500. User computer 505a or 505b may connect directly to the Internet (e.g., via a cable modem). User computer 505c may be internal to the data center 500 and may connect directly to the resources in the data center 500 via internal networks. Although only three user computers 505a,505b, and 505c are depicted, it should be appreciated that there may be multiple user computers.

Computers 505 may also be utilized to configure aspects of the computing resources provided by data center 500. For example, data center 500 may provide a Web interface through which aspects of its operation may be configured through the use of a Web browser application program executing on user computer 505. Alternatively, a stand-alone application program executing on user computer 505 may be used to access an application programming interface (API) exposed by data center 500 for performing the configuration operations.

Servers 556 may be configured to provide the computing resources described above. One or more of the servers 556 may be configured to execute a manager 550a or 550b (which may be referred herein singularly as “a manager 530” or in the plural as “the managers 530”) configured to execute the virtual machines. The managers 530 may be a virtual machine monitor (VMM), fabric controller, or another type of program configured to enable the execution of virtual machines 555 on servers 556, for example.

It should be appreciated that although the embodiments disclosed above are discussed in the context of virtual machines, other types of implementations can be utilized with the concepts and technologies disclosed herein.

In the example data center 500 shown in FIG. 5, a network device 575 may be utilized to interconnect the servers 556a and 556b. Network device 575 may comprise one or more switches, routers, or other network devices. Network device 575 may also be connected to gateway 540, which is connected to communications network 550. Network device 575 may facilitate communications within networks in data center 500, for example, by forwarding packets or other data communications as appropriate based on characteristics of such communications (e.g., header information including source and/or destination addresses, protocol identifiers, etc.) and/or the characteristics of the private network (e.g., routes based on network topology, etc.). It will be appreciated that, for the sake of simplicity, various aspects of the computing systems and other devices of this example are illustrated without showing certain conventional details. Additional computing systems and other devices may be interconnected in other embodiments and may be interconnected in different ways.

It should be appreciated that the network topology illustrated in FIG. 5 has been greatly simplified and that many more networks and networking devices may be utilized to interconnect the various computing systems disclosed herein. These network topologies and devices should be apparent to those skilled in the art.

It should also be appreciated that data center 500 described in FIG. 5 is merely illustrative and that other implementations might be utilized. Additionally, it should be appreciated that the functionality disclosed herein might be implemented in software, hardware or a combination of software and hardware. Other implementations should be apparent to those skilled in the art. It should also be appreciated that a server, gateway, or other computing device may comprise any combination of hardware or software that can interact and perform the described types of functionality, including without limitation desktop or other computers, database servers, network storage devices and other network devices, PDAs, tablets, smartphone, Internet appliances, television-based systems (e.g., using set top boxes and/or personal/digital video recorders), and various other consumer products that include appropriate communication capabilities. In addition, the functionality provided by the illustrated modules may in some embodiments be combined in fewer modules or distributed in additional modules. Similarly, in some embodiments the functionality of some of the illustrated modules may not be provided and/or other additional functionality may be available.

In some embodiments, aspects of the present disclosure may be implemented in a mobile edge computing (MEC) environment implemented in conjunction with a 4G, 5G, or other cellular network. MEC is a type of edge computing that uses cellular networks and 5G and enables a data center to extend cloud services to local deployments using a distributed architecture that provide federated options for local and remote data and control management. MEC architectures may be implemented at cellular base stations or other edge nodes and enable operators to host content closer to the edge of the network, delivering high-bandwidth, low-latency applications to end users. For example, the cloud provider's footprint may be co-located at a carrier site (e.g., carrier data center), allowing for the edge infrastructure and applications to run closer to the end user via the 5G network.

It should be appreciated that the subject matter presented herein may be implemented as a computer process, a computer-controlled apparatus, a computing system, an article of manufacture, such as a computer-readable storage medium, or a component including hardware logic for implementing functions, such as a field-programmable gate array (FPGA) device, a massively parallel processor array (MPPA) device, a graphics processing unit (GPU), an application-specific integrated circuit (ASIC), a multiprocessor System-on-Chip (MPSoC), etc.

A component may also encompass other ways of leveraging a device to perform a function, such as, for example, a) a case in which at least some tasks are implemented in hard ASIC logic or the like; b) a case in which at least some tasks are implemented in soft (configurable) FPGA logic or the like; c) a case in which at least some tasks run as software on FPGA software processor overlays or the like; d) a case in which at least some tasks run as software on hard ASIC processors or the like, etc., or any combination thereof. A component may represent a homogeneous collection of hardware acceleration devices, such as, for example, FPGA devices. On the other hand, a component may represent a heterogeneous collection of different types of hardware acceleration devices including different types of FPGA devices having different respective processing capabilities and architectures, a mixture of FPGA devices and other types hardware acceleration devices, etc.

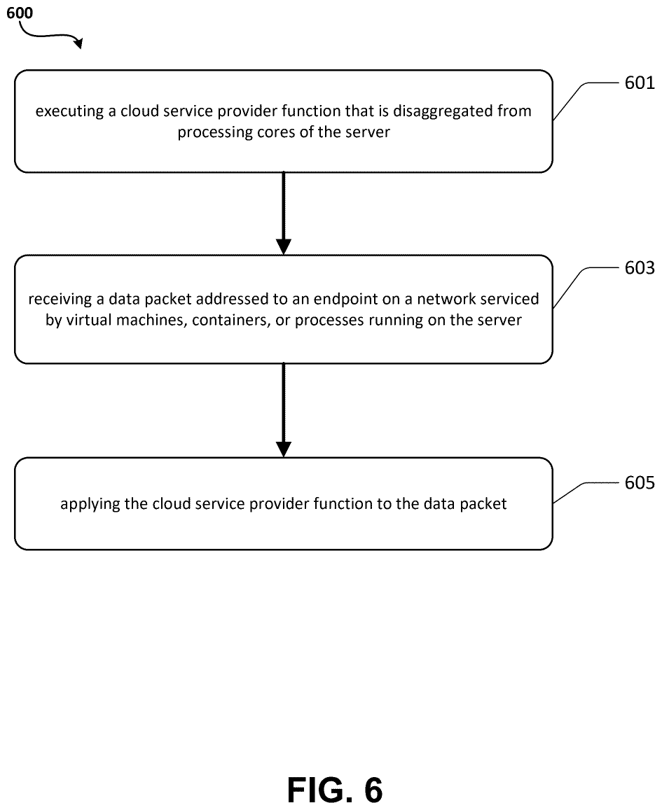

Turning now to FIG. 6, illustrated is an example operational procedure 600 for processing data in a computing environment comprising a computing service provider and an edge computing network. In an embodiment, the edge computing network comprises computing and storage devices configured to extend computing resources of the computing service provider to remote users of the computing service provider at a location remote from the computer service provider. In an embodiment, the edge computing network comprises a server communicatively coupled to a digital processing unit (DPU). Such an operational procedure can be provided by one or more components illustrated in FIGS. 1 through 5. The operational procedure may be implemented in a system comprising one or more computing devices. It should be understood by those of ordinary skill in the art that the operations of the methods disclosed herein are not necessarily presented in any particular order and that performance of some or all of the operations in an alternative order(s) is possible and is contemplated. The operations have been presented in the demonstrated order for ease of description and illustration. Operations may be added, omitted, performed together, and/or performed simultaneously, without departing from the scope of the appended claims.

It should also be understood that the illustrated methods can end at any time and need not be performed in their entireties. Some or all operations of the methods, and/or substantially equivalent operations, can be performed by execution of computer-readable instructions included on a computer-storage media, as defined herein. The term “computer-readable instructions,” and variants thereof, as used in the description and claims, is used expansively herein to include routines, applications, application modules, program modules, programs, components, data structures, algorithms, and the like. Computer-readable instructions can be implemented on various system configurations, including single-processor or multiprocessor systems, minicomputers, mainframe computers, personal computers, hand-held computing devices, microprocessor-based, programmable consumer electronics, combinations thereof, and the like.

It should be appreciated that the logical operations described herein are implemented (1) as a sequence of computer implemented acts or program modules running on a computing system such as those described herein) and/or (2) as interconnected machine logic circuits or circuit modules within the computing system. The implementation is a matter of choice dependent on the performance and other requirements of the computing system. Accordingly, the logical operations may be implemented in software, in firmware, in special purpose digital logic, and any combination thereof. Thus, although the routine 600 is described as running on a system, it can be appreciated that the routine 600 and other operations described herein can be executed on an individual computing device or several devices.

Referring to FIG. 6, operation 601 illustrates executing, on the DPU, a computing service provider function that is disaggregated from processing cores of the server of the edge computing network. In an embodiment, the computing service provider function provides a network management and orchestration service of the computing service provider.

Operation 603 illustrates receiving, by the DPU, a data packet addressed to an endpoint on a network serviced by virtual machines, containers, or processes running on the server of the edge computing network.

Operation 605 illustrates applying, by the DPU, the computing service provider function to the data packet, thereby enabling the data packet to be processed by the DPU prior to being processed by functions running on the processing cores of the server of the edge computing network.

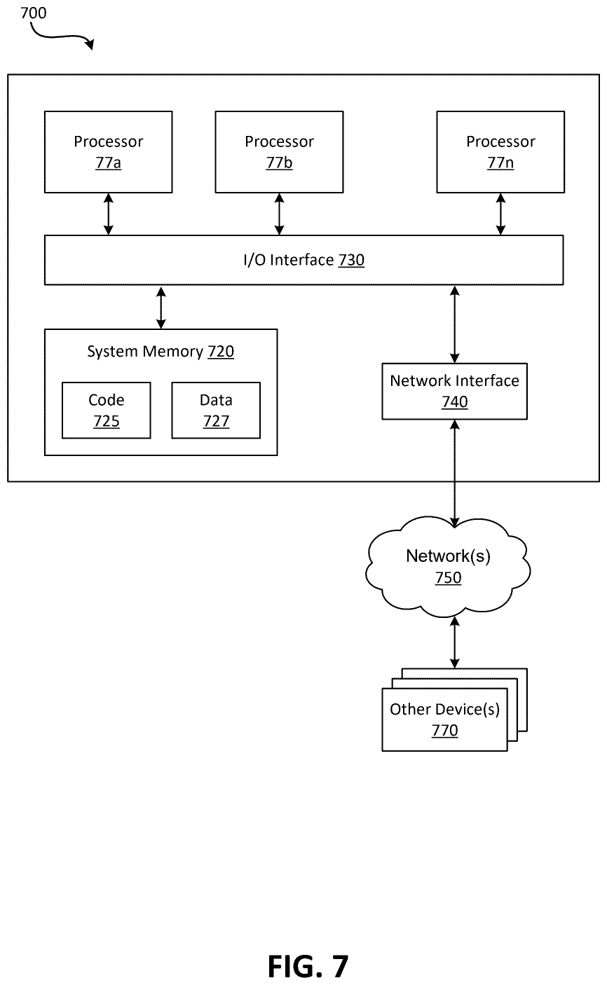

FIG. 7 illustrates a general-purpose computing device 700. In the illustrated embodiment, computing device 700 includes one or more processors 77a, 77b, and/or 77n (which may be referred herein singularly as “a processor 77” or in the plural as “the processors 77”) coupled to a system memory 720 via an input/output (I/O) interface 730. Computing device 700 further includes a network interface 740 coupled to I/O interface 730.

In various embodiments, computing device 700 may be a uniprocessor system including one processor 77 or a multiprocessor system including several processors 77 (e.g., two, four, eight, or another suitable number). Processors 77 may be any suitable processors capable of executing instructions. For example, in various embodiments, processors 77 may be general-purpose or embedded processors implementing any of a variety of instruction set architectures (ISAs), such as the x77, PowerPC, SPARC, or MIPS ISAs, or any other suitable ISA. In multiprocessor systems, each of processors 77 may commonly, but not necessarily, implement the same ISA.

System memory 720 may be configured to store instructions and data accessible by processor(s) 77. In various embodiments, system memory 720 may be implemented using any suitable memory technology, such as static random access memory (SRAM), synchronous dynamic RAM (SDRAM), nonvolatile/Flash-type memory, or any other type of memory. In the illustrated embodiment, program instructions and data implementing one or more desired functions, such as those methods, techniques and data described above, are shown stored within system memory 720 as code 725 and data 727.

In one embodiment, I/O interface 730 may be configured to coordinate I/O traffic between the processor 77, system memory 720, and any peripheral devices in the device, including network interface 740 or other peripheral interfaces. In some embodiments, I/O interface 730 may perform any necessary protocol, timing, or other data transformations to convert data signals from one component (e.g., system memory 720) into a format suitable for use by another component (e.g., processor 77). In some embodiments, I/O interface 730 may include support for devices attached through various types of peripheral buses, such as a variant of the Peripheral Component Interconnect (PCI) bus standard or the Universal Serial Bus (USB) standard, for example. In some embodiments, the function of I/O interface 730 may be split into two or more separate components. Also, in some embodiments some or all of the functionality of I/O interface 730, such as an interface to system memory 720, may be incorporated directly into processor 77.

Network interface 740 may be configured to allow data to be exchanged between computing device 700 and other device or devices 770 attached to a network or network(s) 750, such as other computer systems or devices as illustrated in FIGS. 1 through 5, for example. In various embodiments, network interface 740 may support communication via any suitable wired or wireless general data networks, such as types of Ethernet networks, for example. Additionally, network interface 740 may support communication via telecommunications/telephony networks such as analog voice networks or digital fiber communications networks, via storage area networks such as Fibre Channel SANs or via any other suitable type of network and/or protocol.

In some embodiments, system memory 720 may be one embodiment of a computer-accessible medium configured to store program instructions and data as described above for the Figures for implementing embodiments of the corresponding methods and apparatus. However, in other embodiments, program instructions and/or data may be received, sent or stored upon different types of computer-accessible media. A computer-accessible medium may include non-transitory storage media or memory media, such as magnetic or optical media, e.g., disk or DVD/CD coupled to computing device 700 via I/O interface 730. A non-transitory computer-accessible storage medium may also include any volatile or non-volatile media, such as RAM (e.g. SDRAM, DDR SDRAM, RDRAM, SRAM, etc.), ROM, etc., that may be included in some embodiments of computing device 700 as system memory 720 or another type of memory. Further, a computer-accessible medium may include transmission media or signals such as electrical, electromagnetic or digital signals, conveyed via a communication medium such as a network and/or a wireless link, such as may be implemented via network interface 740. Portions or all of multiple computing devices, such as those illustrated in FIG. 7, may be used to implement the described functionality in various embodiments; for example, software components running on a variety of different devices and servers may collaborate to provide the functionality. In some embodiments, portions of the described functionality may be implemented using storage devices, network devices, or special-purpose computer systems, in addition to or instead of being implemented using general-purpose computer systems. The term “computing device,” as used herein, refers to at least all these types of devices and is not limited to these types of devices.

Various storage devices and their associated computer-readable media provide non-volatile storage for the computing devices described herein. Computer-readable media as discussed herein may refer to a mass storage device, such as a solid-state drive, a hard disk or CD-ROM drive. However, it should be appreciated by those skilled in the art that computer-readable media can be any available computer storage media that can be accessed by a computing device.

By way of example, and not limitation, computer storage media may include volatile and non-volatile, removable and non-removable media implemented in any method or technology for storage of information such as computer-readable instructions, data structures, program modules or other data. For example, computer media includes, but is not limited to, RAM, ROM, EPROM, EEPROM, flash memory or other solid state memory technology, CD-ROM, digital versatile disks (“DVD”), HD-DVD, BLU-RAY, or other optical storage, magnetic cassettes, magnetic tape, magnetic disk storage or other magnetic storage devices, or any other medium which can be used to store the desired information and which can be accessed by the computing devices discussed herein. For purposes of the claims, the phrase “computer storage medium,” “computer-readable storage medium” and variations thereof, does not include waves, signals, and/or other transitory and/or intangible communication media, per se.

Encoding the software modules presented herein also may transform the physical structure of the computer-readable media presented herein. The specific transformation of physical structure may depend on various factors, in different implementations of this description. Examples of such factors may include, but are not limited to, the technology used to implement the computer-readable media, whether the computer-readable media is characterized as primary or secondary storage, and the like. For example, if the computer-readable media is implemented as semiconductor-based memory, the software disclosed herein may be encoded on the computer-readable media by transforming the physical state of the semiconductor memory. For example, the software may transform the state of transistors, capacitors, or other discrete circuit elements constituting the semiconductor memory. The software also may transform the physical state of such components in order to store data thereupon.

As another example, the computer-readable media disclosed herein may be implemented using magnetic or optical technology. In such implementations, the software presented herein may transform the physical state of magnetic or optical media, when the software is encoded therein. These transformations may include altering the magnetic characteristics of particular locations within given magnetic media. These transformations also may include altering the physical features or characteristics of particular locations within given optical media, to change the optical characteristics of those locations. Other transformations of physical media are possible without departing from the scope and spirit of the present description, with the foregoing examples provided only to facilitate this discussion.

In light of the above, it should be appreciated that many types of physical transformations take place in the disclosed computing devices in order to store and execute the software components and/or functionality presented herein. It is also contemplated that the disclosed computing devices may not include all of the illustrated components shown in FIG. 7, may include other components that are not explicitly shown in FIG. 7, or may utilize an architecture completely different than that shown in FIG. 7.

Although the various configurations have been described in language specific to structural features and/or methodological acts, it is to be understood that the subject matter defined in the appended representations is not necessarily limited to the specific features or acts described. Rather, the specific features and acts are disclosed as example forms of implementing the claimed subject matter.

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements, and/or steps. Thus, such conditional language is not generally intended to imply that features, elements, and/or steps are in any way required for one or more embodiments or that one or more embodiments necessarily include logic for deciding, with or without author input or prompting, whether these features, elements, and/or steps are included or are to be performed in any particular embodiment. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list.

While certain example embodiments have been described, these embodiments have been presented by way of example only, and are not intended to limit the scope of the inventions disclosed herein. Thus, nothing in the foregoing description is intended to imply that any particular feature, characteristic, step, module, or block is necessary or indispensable. Indeed, the novel methods and systems described herein may be embodied in a variety of other forms; furthermore, various omissions, substitutions and changes in the form of the methods and systems described herein may be made without departing from the spirit of the inventions disclosed herein. The accompanying claims and their equivalents are intended to cover such forms or modifications as would fall within the scope and spirit of certain of the inventions disclosed herein.

It should be appreciated any reference to “first,” “second,” etc. items and/or abstract concepts within the description is not intended to and should not be construed to necessarily correspond to any reference of “first,” “second,” etc. elements of the claims. In particular, within this Summary and/or the following Detailed Description, items and/or abstract concepts such as, for example, individual computing devices and/or operational states of the computing cluster may be distinguished by numerical designations without such designations corresponding to the claims or even other paragraphs of the Summary and/or Detailed Description. For example, any designation of a “first operational state” and “second operational state” of the computing cluster within a paragraph of this disclosure is used solely to distinguish two different operational states of the computing cluster within that specific paragraph—not any other paragraph and particularly not the claims.

Although the various techniques have been described in language specific to structural features and/or methodological acts, it is to be understood that the subject matter defined in the appended representations is not necessarily limited to the specific features or acts described. Rather, the specific features and acts are disclosed as example forms of implementing the claimed subject matter.

The disclosure presented herein also encompasses the subject matter set forth in the following clauses:

Clause 1: A method for processing data in a computing environment comprising a computing service provider and an edge computing network, the edge computing network comprising computing and storage devices configured to extend computing resources of the computing service provider to remote users of the computing service provider at a location remote from the computer service provider, the edge computing network comprising a server communicatively coupled to a digital processing unit (DPU), the method comprising: executing, on the DPU, a computing service provider function that is disaggregated from processing cores of the server of the edge computing network, the computing service provider function providing a network management and orchestration service of the computing service provider; receiving, by the DPU, a data packet addressed to an endpoint on a network serviced by virtual machines, containers, or processes running on the server of the edge computing network; and applying, by the DPU, the computing service provider function to the data packet, thereby enabling the data packet to be processed by the DPU prior to being processed by functions running on the processing cores of the server of the edge computing network.

Clause 2: The method of clause 1, wherein the computing service provider function comprises one of a compute fabric, network fabric, or storage fabric.

Clause 3: The method of any of clauses 1-2, wherein the DPU is a root of trust for the computing service provider at the edge computing network.

Clause 4: The method of any of clauses 1-3, wherein the root of trust enables secure installation of operating systems or applications from the computing service provider at the edge computing network.

Clause 5: The method of any of clauses 1-4, wherein the DPU is configured to cause data traffic to be forwarded to a different server at the edge computing network or another edge computing network when a failure is detected at the server.

Clause 6: The method of any of clauses 1-5, wherein the DPU is located on a DPU complex comprising a plurality of DPUs.

Clause 7: The method of any of clauses 1-6, further comprising applying a plurality of computing service provider function by the plurality of DPUs.

Clause 8: The method of any of clauses 1-7, wherein the DPU is configured to operate a plurality of processing paths, further comprising assigning the computing service provider function to a selected one of the processing paths.

Clause 9: The method of any of clauses 1-8, wherein the one processing path is dynamically selected based on incoming workloads or determined based on a configuration.

Clause 10: An edge computing network comprising computing and storage devices configured to extend computing resources of a computing service provider to remote users of the computing service provider at a location remote from the computer service provider, the edge computing network comprising a server communicatively coupled to a digital processing unit (DPU), the DPU configured to: perform operations comprising: executing a computing service provider function that is disaggregated from processing cores of the server, the computing service provider function providing a network management and orchestration service of the computing service provider; receiving a data packet addressed to an endpoint on a network serviced by virtual machines, containers, or processes running on the server; and applying the computing service provider function to the data packet, thereby enabling the data packet to be processed by the DPU prior to being processed by functions running on the processing cores of the server.

Clause 11: The edge computing network of clause 10, wherein the computing service provider function comprises one of a compute fabric, network fabric, or storage fabric.

Clause 12: The edge computing network of any of clauses 10 and 11, wherein the DPU is a root of trust for the computing service provider at the edge computing network.

Clause 13: The edge computing network of any clauses 10-12, wherein the root of trust enables secure installation of operating systems or applications from the computing service provider at the edge computing network.

Clause 14: The edge computing network of any clauses 10-13, wherein the DPU is configured to cause data traffic to be forwarded to a different server at the edge computing network or another edge computing network when a failure is detected at the server.

Clause 15: The hardware-based networking device of any clauses 10-14, wherein the DPU is located on a DPU complex comprising a plurality of DPUs.

Clause 16: The hardware-based networking device of any clauses 10-15, further comprising applying a plurality of computing service provider function by the plurality of DPUs.

Clause 17: A digital processing unit (DPU) configured to disaggregate computing service provider functions of a cloud service provider from hosts of an edge computing network, the hosts implemented on servers hosting a plurality of virtual machines or containers, the edge computing network comprising computing and storage devices configured to extend computing resources of the cloud service provider to remote users of the cloud service provider at a location remote from the cloud service provider, the servers coupled to the DPU, the DPU configured to perform operations comprising:
executing a cloud service provider function that is disaggregated from processing cores of the servers;
receiving a data packet addressed to an endpoint on a network serviced by virtual machines, containers, or processes running on the servers; and
applying the cloud service provider function to the data packet, thereby enabling the data packet to be processed by the DPU prior to being processed by functions running on the processing cores of the servers.

Clause 18: The DPU of clause 17, wherein the cloud service provider function comprises one of a compute fabric, network fabric, or storage fabric.

Clause 19: The DPU of any of clauses 17 and 18, wherein the DPU is a root of trust for the cloud service provider at the edge computing network.

Clause 20: The DPU of any of clauses 17-19, wherein the DPU is configured to cause data traffic to be forwarded to a different server at the edge computing network or another edge computing network when a failure is detected at the servers.

What is claimed is:

1. A method for processing data in a computing environment comprising a computing service provider and an edge computing network, the edge computing network comprising computing and storage devices configured to extend computing resources of the computing service provider to remote users of the computing service provider at a location remote from the computer service provider, the edge computing network comprising a server communicatively coupled to a digital processing unit (DPU), the method comprising:
executing, on the DPU, a computing service provider function that is disaggregated from processing cores of the server of the edge computing network, the computing service provider function providing a network management and orchestration service of the computing service provider;
receiving, by the DPU, a data packet addressed to an endpoint on a network serviced by virtual machines, containers, or processes running on the server of the edge computing network; and
applying, by the DPU, the computing service provider function to the data packet, thereby enabling the data packet to be processed by the DPU prior to being processed by functions running on the processing cores of the server of the edge computing network.

2. The method of claim 1, wherein the computing service provider function comprises one of a compute fabric, network fabric, or storage fabric.

3. The method of claim 1, wherein the DPU is a root of trust for the computing service provider at the edge computing network.

4. The method of claim 3, wherein the root of trust enables secure installation of operating systems or applications from the computing service provider at the edge computing network.

5. The method of claim 1, wherein the DPU is configured to cause data traffic to be forwarded to a different server at the edge computing network or another edge computing network when a failure is detected at the server.

6. The method of claim 1, wherein the DPU is located on a DPU complex comprising a plurality of DPUs.

7. The method of claim 6, further comprising applying a plurality of computing service provider function by the plurality of DPUs.

8. The method of claim 1, wherein the DPU is configured to operate a plurality of processing paths, further comprising assigning the computing service provider function to a selected one of the processing paths.

9. The method of claim 8, wherein the one processing path is dynamically selected based on incoming workloads or determined based on a configuration.

10. An edge computing network comprising computing and storage devices configured to extend computing resources of a computing service provider to remote users of the computing service provider at a location remote from the computer service provider, the edge computing network comprising a server communicatively coupled to a digital processing unit (DPU), the DPU configured to: perform operations comprising:
executing a computing service provider function that is disaggregated from processing cores of the server, the computing service provider function providing a network management and orchestration service of the computing service provider;
receiving a data packet addressed to an endpoint on a network serviced by virtual machines, containers, or processes running on the server; and
applying the computing service provider function to the data packet, thereby enabling the data packet to be processed by the DPU prior to being processed by functions running on the processing cores of the server.

11. The edge computing network of claim 10, wherein the computing service provider function comprises one of a compute fabric, network fabric, or storage fabric.

12. The edge computing network of claim 10, wherein the DPU is a root of trust for the computing service provider at the edge computing network.

13. The edge computing network of claim 12, wherein the root of trust enables secure installation of operating systems or applications from the computing service provider at the edge computing network.

14. The edge computing network of claim 10, wherein the DPU is configured to cause data traffic to be forwarded to a different server at the edge computing network or another edge computing network when a failure is detected at the server.

15. The edge computing network of claim 10, wherein the DPU is located on a DPU complex comprising a plurality of DPUs.

16. The edge computing network of claim 15, further comprising applying a plurality of computing service provider function by the plurality of DPUs.

17. A digital processing unit (DPU) configured to disaggregate computing service provider functions of a cloud service provider from hosts of an edge computing network, the hosts implemented on servers hosting a plurality of virtual machines or containers, the edge computing network comprising computing and storage devices configured to extend computing resources of the cloud service provider to remote users of the cloud service provider at a location remote from the cloud service provider, the servers coupled to the DPU, the DPU configured to perform operations comprising:
executing a cloud service provider function that is disaggregated from processing cores of the servers;
receiving a data packet addressed to an endpoint on a network serviced by virtual machines, containers, or processes running on the servers; and
applying the cloud service provider function to the data packet, thereby enabling the data packet to be processed by the DPU prior to being processed by functions running on the processing cores of the servers.

18. The DPU of claim 17, wherein the cloud service provider function comprises one of a compute fabric, network fabric, or storage fabric.

19. The DPU of claim 17, wherein the DPU is a root of trust for the cloud service provider at the edge computing network.

20. The DPU of claim 17, wherein the DPU is configured to cause data traffic to be forwarded to a different server at the edge computing network or another edge computing network when a failure is detected at the servers.
